(19) United States
(12) Patent Application Publication
(10) Pub. No.: US 2025/0209429 A1
(43) Pub. Date: Jun. 26, 2025

(54) ENHANCED AUTOPAYMENT FEATURES USING OPEN BANKING

(71) Applicant: MASTERCARD INTERNATIONAL INCORPORATED, Purchase, NY (US)

(72) Inventors: Vidur Datt, Syosset, NY (US); Greg White, Tuckahoe, NY (US)

(21) Appl. No.: 18/989,848

(22) Filed: Dec. 20, 2024

Related U.S. Application Data
(60) Provisional application No. 63/612,823, filed on Dec. 20, 2023.

(51) Int. Cl. G06Q 20/10; G06Q 40/02

(52) U.S. Cl. CPC G06Q 20/102; G06Q 20/108; G06Q 40/02

(57) ABSTRACT

A method can include establishing, at a banking application, a connection with a bank-as-biller account associated with a financial institution different than that of the banking application using an open banking identifier associated with the bank-as-biller account, wherein the bank-as-biller account has a biller identifier for electronic payment to the bank-as-biller account; obtaining, on a current day, at the banking application via the connection with the bank-as-biller account, a current balance for the bank-as-biller account that reflects an actual balance including after any transactions posted for the bank-as-biller account for the current day; determining an amount to pay towards the current balance for the bank-as-biller account based on the current balance; and directing payment of the amount to pay towards the current balance by performing an electronic payment using the biller identifier associated with the bank-as-biller account to effect the electronic payment for the bank-as-biller account on the current day.

### CROSS REFERENCE TO RELATED APPLICATIONS

This application claims priority to U.S. Provisional Patent Application Ser. No. 63/612,823, filed Dec. 20, 2023.

All of the foregoing patent applications are incorporated herein by reference in their entirety.

### BACKGROUND

Banking applications can provide an online bill-pay opportunity. In some cases, the financial institution associated with the banking application can directly transfer funds (e.g., to a payee account) through a payment or banking rail. In other cases, the financial institution may mail a physical check to the payee.

However, the information available within a user's banking application for online bill-pay tends to be limited. This is especially true for autopayments set up at the banking application to send funds to the finanical institution. Currently, a user may opt to make an autopayment of a minimum due for an account, which may vary month to month (e.g., credit or debit card account). However, the banking application still relies on the e-bill to facilitate the autopayment. The banking application may only receive an e-bill once per payment term, and on a specific date of the month.

Indeed, the banking application receives an e-bill on the 1^{st} of every month, the e-bill will only include transactions up and until the 1^{st} of the month. The user is unable to set up autopayments from the banking application that pay a current balance up and until a particular day they wish to pay.

### BRIEF SUMMARY

Systems and methods for facilitating an autopayment for a current balance on a current day from a banking application to a different financial institution are described. Advantageously, the banking application can leverage electronic payment functionality and open banking functionality to enable enhanced autopayment features for users.

In some aspects, the techniques described herein relate to a method, including: establishing, at a banking application, a connection with a bank-as-biller account associated with a financial institution different than that of the banking application using an open banking identifier associated with the bank-as-biller account, wherein the bank-as-biller account has a biller identifier for electronic payment to the bank-as-biller account; obtaining, on a current day, at the banking application via the connection with the bank-as-biller account, a current balance for the bank-as-biller account that reflects an actual balance including after any transactions posted for the bank-as-biller account for the current day; determining an amount to pay towards the current balance for the bank-as-biller account based on the current balance; and directing payment of the amount to pay towards the current balance by performing an electronic payment using the biller identifier associated with the bank-as-biller account to effect the electronic payment for the bank-as-biller account on the current day.

In some aspects, the techniques described herein relate to a method, including: establishing, at a banking application, a connection with a bank-as-biller account associated with a financial institution different than that of the banking application using an open banking identifier associated with the bank-as-biller account, wherein the bank-as-biller account has a biller identifier for electronic payment to the bank-as-biller account; obtaining on a current day, at the banking application via the connection with the bank-as-biller account, a current balance for the bank-as-biller account that reflects an actual account balance including after any transactions posted for the bank-as-biller account for the current day, wherein the current balance is for a term loan; determining that the current balance is zero; and based on determining that the current balance is zero, cancelling an autopayment associated with the bank-as-biller account.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment of an in-application transaction interface.

FIGS. 2A-2E illustrate a transaction detail display and payment flow utilizing an in-application transaction interface.

FIGS. 3A and 3B illustrate process flow diagrams of methods of operating an in-application transaction interface for the transaction detail display and payment flow shown in FIGS. 2A-2E.

FIGS. 4A-4D illustrates an example consent process for a bank as a biller in a banking application.

FIG. 5A-5E illustrates a mortgage payment detail display and payment flow utilizing an in-application transaction interface.

FIG. 6A-6D illustrates an additional example consent process for a bank as a biller in a banking application.

FIG. 7A illustrates an example process for an autopayment for a variable bill on a current day.

FIG. 7B illustrates a method of completing an autopayment for a variable bill for a bank-as-biller account at a banking application.

FIG. 8 illustrates an example method for cancelling an autopayment for a term loan.

FIG. 9 illustrates a block diagram illustrating components of a computing device used in some embodiments.

### DETAILED DESCRIPTION

An in-application transaction interface is provided that enables a user to receive bill content through bill pay open banking. Through the described systems and methods, it is possible to include bill content in a banking application of a first financial institution for bill types including credit card, mortgage, home equity loan and auto loan bills through other financial institutions.

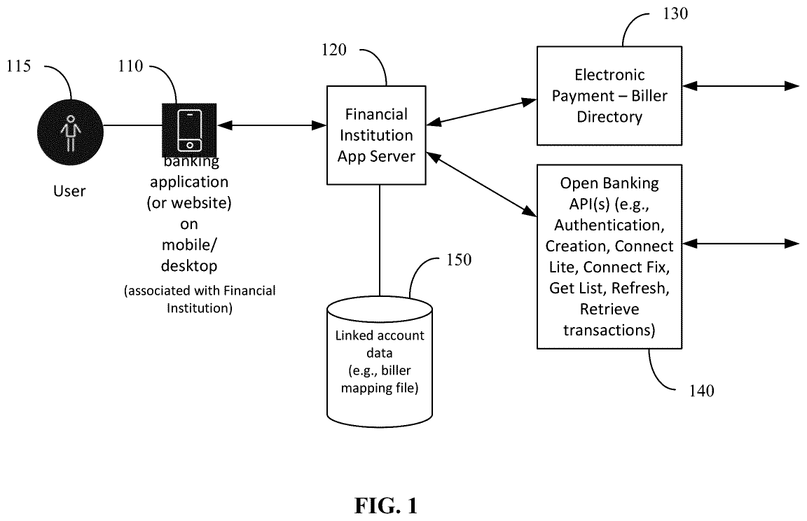

FIG. 1 illustrates an operating environment of an in-application transaction interface. Referring to FIG. 1, a banking application 110 executed on a mobile device or desktop computer can include an in-application transaction interface supporting bill content and transaction-level details for bills associated with other financial institutions that a user 115 has accounts with. For example, the described interface is useful for credit card, line of credit, mortgage, loans, and auto loans, as some examples. The banking application leverages electronic payment functionality and open banking functionality to enable an in-application transaction interface.

For example, the banking application 110 (directly at the mobile device or desktop computer or via a financial institution application server 120 that supports the banking application) accesses two data streams—open banking API(s) 140 and electronic payment biller directory 130 to obtain bill and account content of another financial institution as well as effect payment towards that bill and/or account. The electronic payment biller directory 130 can be the remote payment and presentment service (RPPS) provided by MASTERCARD. The open banking APIs 140 can include 7 APIs (described in detail herein) to authenticate a Payer and pull required bill content. In some cases, the open banking APIs are supported by the FINICITY open banking platform.

Since the two types of data streams (electronic payment and open banking) access separate systems, a linked account data file is generated and provided to the financial institution application server 120 so that actions with respect to the open banking API(s) 140 can be mapped to entities available through the electronic payment biller directory 130. This linked account data file can be a Biller Mapping file, which contains a list of Biller identifiers (IDs) available through the electronic payment biller directory 130, each with an associated open banking identifier. The linked account data file can be stored in a data storage resource 150 that is accessible by or associated with the financial institution application server 120.

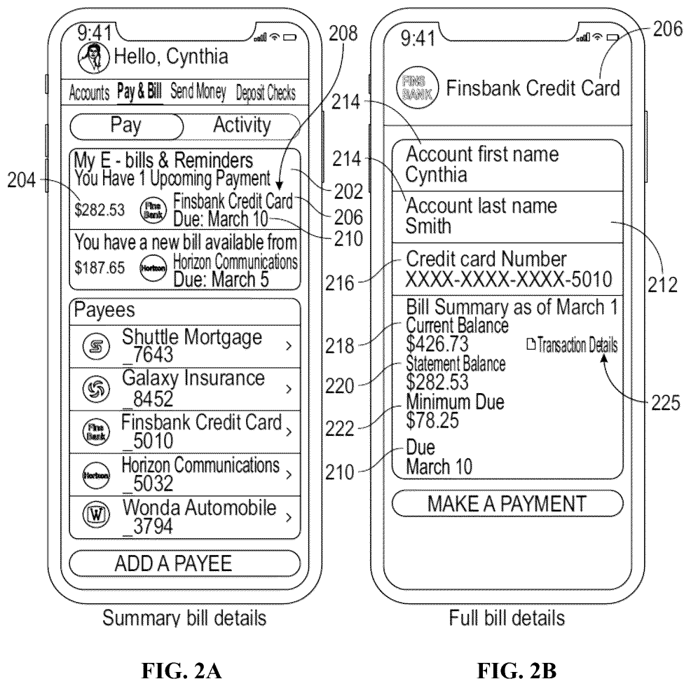

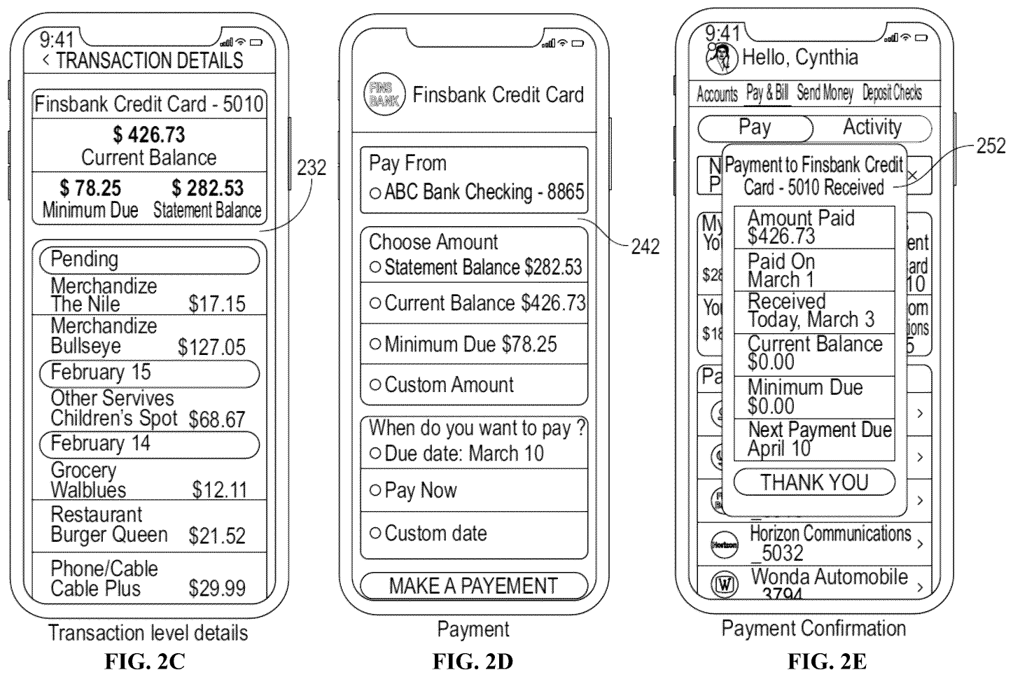

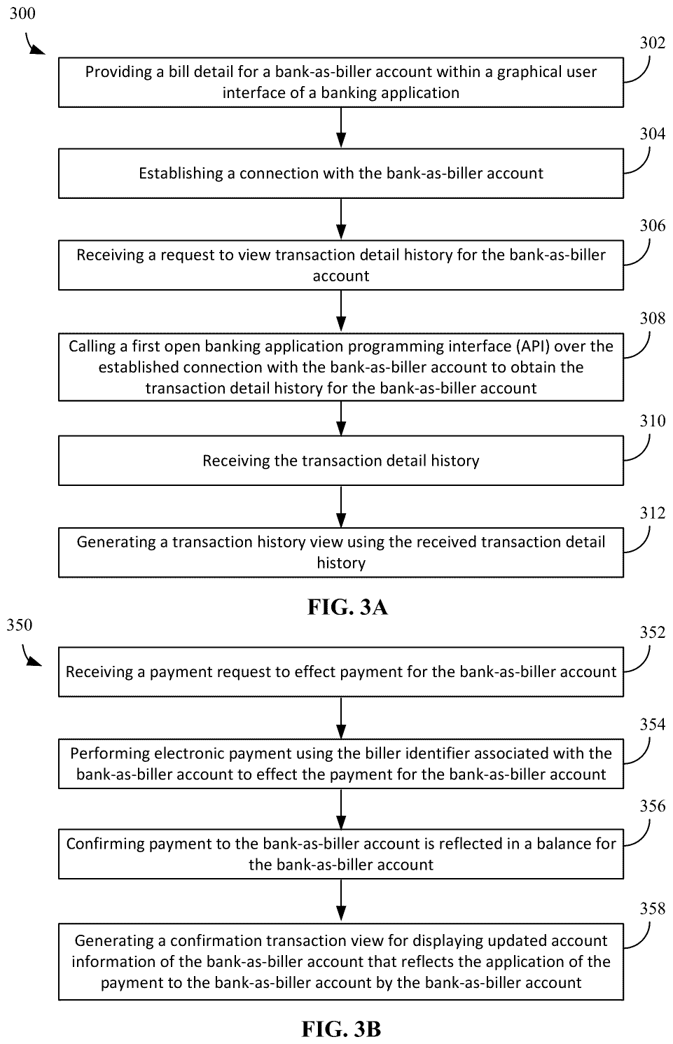

FIGS. 2A-2E illustrates a transaction detail display and payment flow utilizing an in- application transaction interface; and FIGS. 3A and 3B illustrate process flow diagrams of methods of operating an in-application transaction interface for the transaction detail display and payment flow shown in FIGS. 2A-2E. Conventionally, a user can select a payee displayed in a banking application graphical user interface and view the general details (in summary or longer form) of an e-bill from within the banking application. For example, referring to FIG. 2A, in the first screen 202, a bill detail (e.g., amount due 204) for a bank-as-biller account (e.g., Finsbank Credit Card 206) is shown within a graphical user interface of a banking application. In the example illustration, the summary bill details 208 of an e-bill includes the name of the payee (Finsbank Credit Card 206), amount due 204 ($282.53), and due date 210 (March 10). As with a variety of banking applications, the example view for paying a bill shown in the first screen 202 includes a listing of payees, including a summary bill detail for e-bills set up with the financial institution associated with the banking application.

Referring to FIG. 2B, as illustrated in the second screen 212, a longer form of the general details of the e-bill for the payee (e.g., Finsbank Credit Card 206) can be displayed. These general details often include payer/account holder name (e.g., first and last name 214), account identifier of the payer to the payee (e.g., credit card number/last four digits of the credit card number 216), current balance 218, statement balance 220, minimum due 222, and due date 210.

However, unlike conventional bill payment interfaces, the banking application can present timely transaction detail history associated with a bank-as-biller account using the described in-application transaction interface. For example, as also shown in the second screen, an icon 225 for transaction details is presented, indicating that transaction details can be obtained by the banking application. In some cases, interaction with icon 225 can initiate the steps of obtaining and providing for display the transaction detail history associated with the bank-as-biller account, as described with respect to FIG. 3A.

With reference to FIG. 3A, a method 300 of operating an in-application transaction interface can include providing (302) a bill detail for a bank-as-biller account within a graphical user interface of a banking application, for example, as illustrated in the first screen 202 and/or second screen 212. At some point in time, the banking application can establish (304) a connection with the bank-as-biller account using an open banking identifier associated with the bank-as-biller account. The banking application can receive (306) a request to view the transaction detail history (e.g., by selection of the payer to view the transaction details); call (308) the open banking API over the established connection with the bank-as-biller account; receive (310) the transaction detail history; and generate (312) a transaction history view using the received transaction detail history. The transaction history view can be displayed in the graphical user interface of the banking application.

In some cases, establishing (304) the connection with the bank-as-biller account includes performing authentication, registration, and connection with a financial institution of the bank-as-biller account using one or more APIs. For example, the Partner Authentication API, Creating an Active Customer API, and Connect Lite API open banking APIs described in more detail herein may be used.

The open banking API used in the calling (306) step can be a first open banking API that gets a specified customer's account transactions associated with a specified bank-as-biller-account identified by the open banking identifier, for example, as described with respect to the open banking API “Get Customer Account Transactions API” or the “Refresh Customer Accounts API”.

An example of a displayed transaction history view is shown in the third screen 232 of FIG. 2C. As mentioned above, the described interface is useful for credit card, line of credit, mortgage, loans, and auto loans from other institutions, as some examples. Different types of accounts can utilize different data usage (e.g., the information useful for a mortgage and loan can include some different pieces of data than a credit card and line of credit). Thus, the banking application can generate different transaction history views (with different data) depending on the type of account. In some cases, the transaction history views reflect the types of information available from bill content.

Although not shown in the example graphical user interface in FIG. 2C, as with the full bill details view for making a payment shown in the second screen, a button for invoking the make payment command can be presented in a transaction level details view (the “transaction view”) of the third screen 232.

Once a payer selects to make a payment, a payment screen, such as the example shown in the fourth screen 242 of FIG. 2D, can be displayed and payment can be made by the banking application.

Advantageously, not only are the transaction level details available within the banking application, through the described in-application transaction interface, a payer is able to confirm that payment has been received and applied to the account. Indeed, instead of only being able to confirm that payment has been sent, it is possible to confirm that payment is received and applied to the account. For example, as shown in the fifth screen 252 of FIG. 2E, the banking application can display that the payment was received along with the updated balance for that account as part of a confirmation transaction view. The banking application is able to provide this information through calling one of the open banking APIs. For example, updated information can be pulled at regular intervals (such as once per 24 hours or some other time frame) using one of the open banking APIs. In some cases, the responses to the API calls can indicate the freshness of the data for the account information.

For example, turning to FIG. 3B, method 350 can include receiving (352) a payment request to effect payment for the bank-as-biller account; performing (354) a first electronic payment using the biller identifier associated with the bank-as-biller account to effect the payment for the bank-as-biller account; confirming (356) payment to the bank-as-biller account is reflected in a balance for the bank-as-biller account using the established connection with the bank-as-biller account; and generating (358) a confirmation transaction view for displaying updated account information of the bank-as-biller account that reflects the application of the payment to the bank-as-biller account by the bank-as-biller account.

Confirming (356) that the payment to the bank-as-biller account is reflected in the balance for the bank-as-biller account can include calling a second open banking API over the established connection with the bank-as-biller account to obtain updated information including a balance due and an account balance. The second open banking API can be an API that gets updated customer account information such as the balance due and the account balance. The second open banking API can be called at predetermined intervals, periodically, or in response to some trigger (which may be related to a user's activity, timing, etc.).

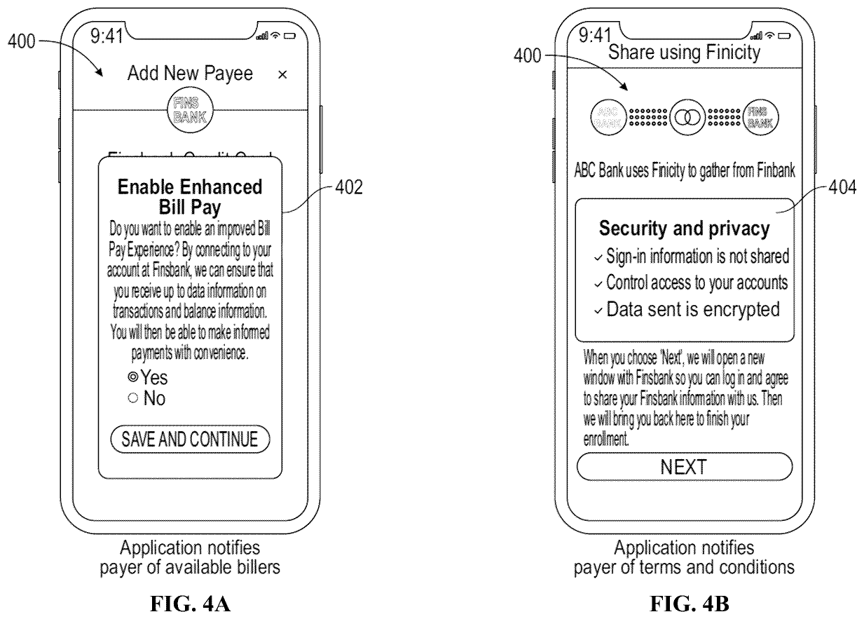

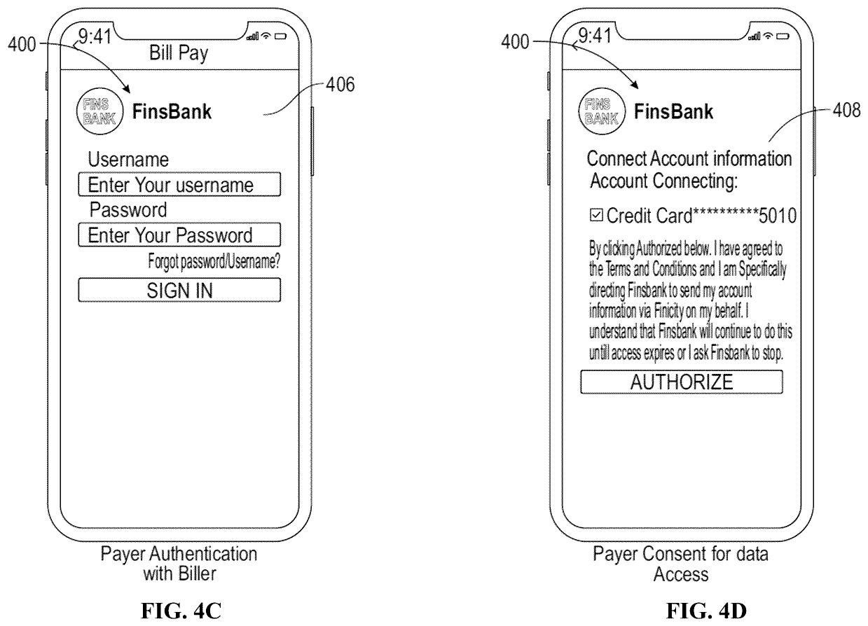

FIGS. 4A-4D illustrates an example consent process for a bank as a biller in a banking application. Referring to FIG. 4A, similar to adding a new payee, a bank as a biller (“bank-as-biller”) can be set up as a payee in the banking application for the electronic payment service.

The financial institution application server checks the linked account data file to determine whether the bank-as-biller has an associated open banking identifier. If the bank-as-biller is determined to have the associated open banking identifier, the banking application can notify the payer that the bill content is available to the payee. For example, the banking application can present an option to receive bill content (e.g., in the graphical user interface). As illustrated in the first screen 402 of the graphical user interface 400, the banking application notifies the payer that bill content is available for a biller.

The payer can select to receive bill content (and accept terms and conditions), for example, by interacting with the graphical user interface of the banking application. The banking application can, in response to receiving the selection by the payer, direct steps to authenticate the payer with the bank-as-biller (e.g., via the open banking API). In addition, the banking application communicates, via the open banking API, the payer's permission to receive the data. For example, referring to FIG. 4B, as illustrated in the second screen 404, terms and conditions can be displayed with a button for the user to interact with for accepting the terms and conditions, as well as other functions for reviewing the information. As illustrated in the third screen 406 shown in FIG. 4C, the payer can enter information, which is sent by the banking application to the biller via one of the open banking APIs for authenticating the payer's credentials with the Biller. As illustrated in the fourth screen 408 shown in FIG. 4D, a graphical user interface displays a screen for the payer to provide consent for the financial institution/banking application to have access to the data.

With this set-up, the banking application establishes a connection with the bank-as-biller-account and can obtain and display bill content and other transaction information to the payer in the graphical user interface. In addition, as explained with respect to FIGS. 2B-2D, the banking application can further include a payment command in the graphical user interface such that in response to receiving a selection of the payment command, the banking application can identify the appropriate biller identifier and effect payment.

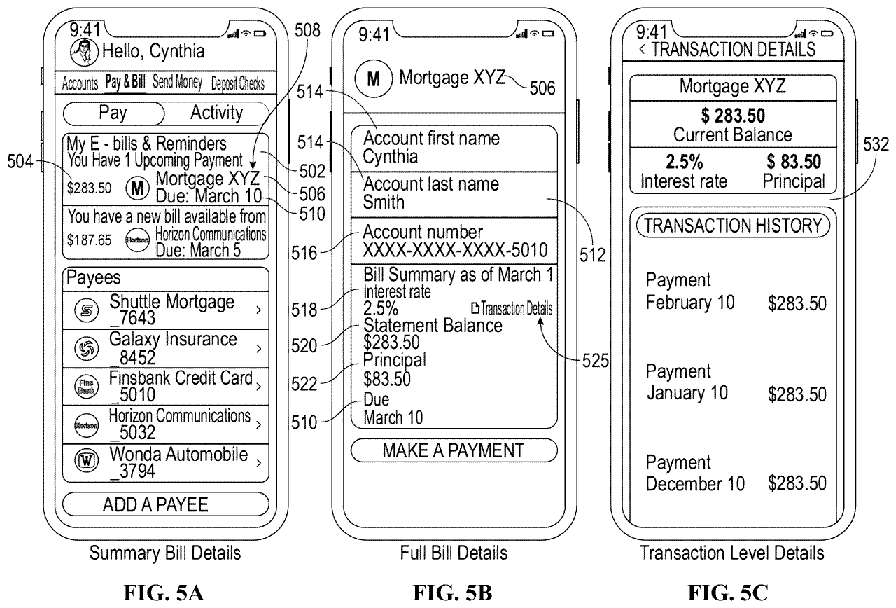

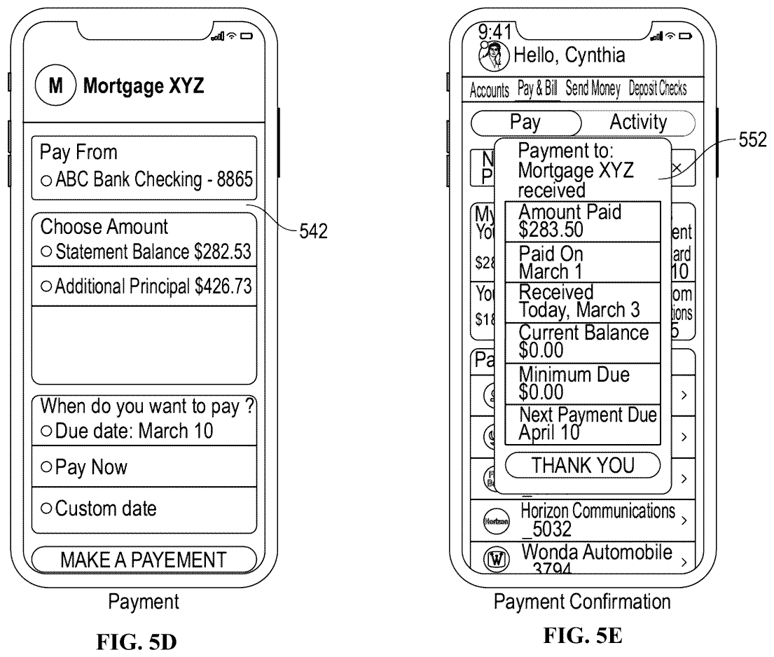

FIGS. 5A-5E illustrates a mortgage payment detail display and payment flow utilizing an in-application transaction interface. Referring to FIG. 5A-5E, account information and payment for mortgages held by financial institutions not associated with a particular payment application can be carried out in-application through the described techniques. For example, referring to FIG. 5A, in the first screen 502, a mortgage payment detail (e.g., amount due 504) for a bank-as-biller account (e.g., payee 506) is shown within a graphical user interface of a banking application. In the example illustration, the summary mortgage payment details 508 of an e-bill includes the name of the payee 506 (Mortgage XYZ), an amount due 504 ($283.50), and a due date 510 (March 10).

Referring to FIG. 5B, as illustrated in the second screen 512, a longer form of the general details of the e-bill for the payee (e.g., payee 506) can be displayed. These general details shown include payer/account holder name (e.g., first and last name 514), account identifier of the payer to the payee (e.g., mortgage account number/last four digits of the mortgage account number 516), interest rate 518 (2.5%), statement balance 520 ($283.50), principal amount 522 ($83.50), and due date 510 (March 10).

Advantageously, the banking application can present timely transaction detail history associated with a mortgage for bank-as-biller account using the described in-application transaction interface. For example, as also shown in the second screen, an icon 525 for transaction details is presented, indicating that transaction details can be obtained by the banking application.

An example of a displayed transaction history view is shown in the third screen 532 of FIG. 5C. Although not shown in the example graphical user interface of FIGS. 5A-5E, as with the full bill details view for making payment shown in the second screen 512, a button for invoking the make payment command can be presented in a transaction level details view (the “transaction view”) of the third screen 532 as shown in FIG. 5C. Once a payer selects to make a payment, a payment screen, such as the example shown in the fourth screen 542 of FIG. 5D, can be displayed and payment can be made by the banking application. As shown in the fifth screen 552 of FIG. 5E, the banking application can display that the mortgage payment was received along with the updated balance for that account as part of a confirmation transaction view. The banking application is able to provide this information through calling one of the open banking APIs.

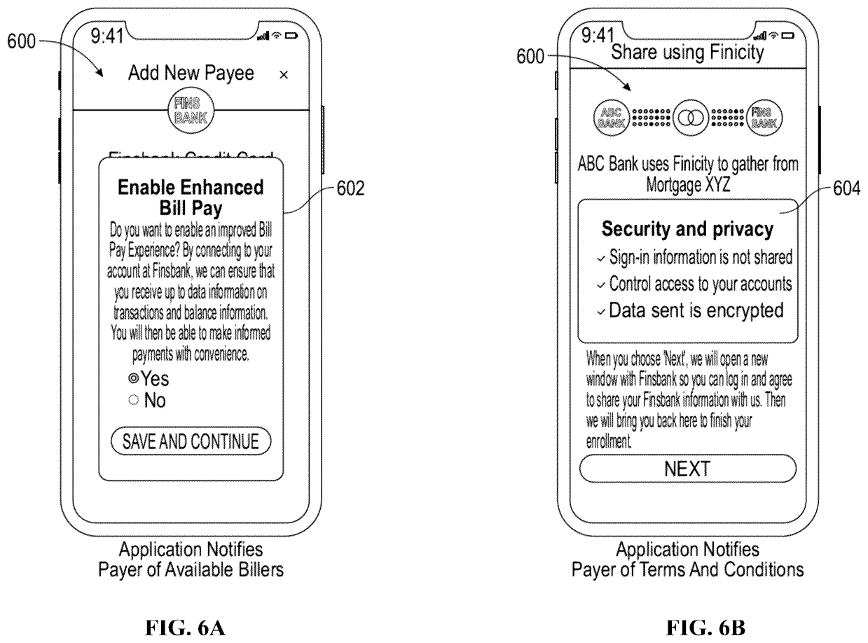

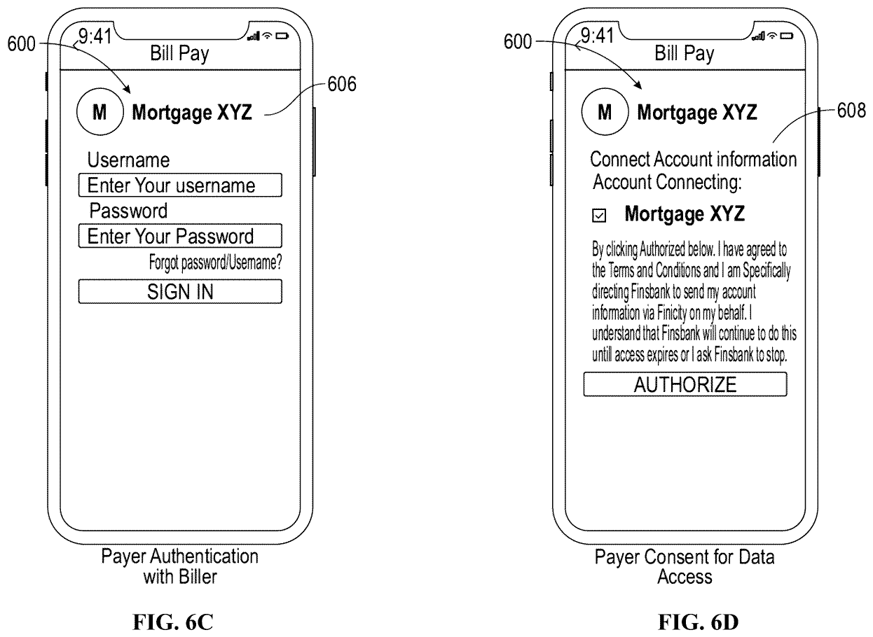

FIGS. 6A-6D illustrates an additional example consent process for a bank as a biller in a banking application. Referring to FIGS. 6A-6D, similar to adding a new payee, a bank as a biller (“bank-as-biller”) for a mortgage can be set up as a payee in the banking application for the electronic payment service.

The financial institution application server checks the linked account data file to determine whether the bank-as-biller has an associated open banking identifier. If the bank-as-biller is determined to have the associated open banking identifier, the banking application can notify the payer that the mortgage bill content is available to the payee. For example, the banking application can present an option to receive mortgage bill content (e.g., in the graphical user interface). Referring to FIG. 6A, as illustrated in the first screen 602 of the graphical user interface 600, the banking application notifies the payer that bill content is available for a biller.

The payer can select to receive mortgage bill content (and accept terms and conditions), for example, by interacting with the graphical user interface of the banking application. The banking application can, in response to receiving the selection by the payer, direct steps to authenticate the payer with the bank-as-biller (e.g., via the open banking API). In addition, the banking application communicates, via the open banking API, the payer's permission to receive the data. For example, as illustrated in the second screen 604 of FIG. 6B, terms and conditions can be displayed with a button for the user to interact with for accepting the terms and conditions, as well as other functions for reviewing the information. As illustrated in the third screen 606 as shown in FIG. 6C, the payer can enter information, which is sent by the banking application to the Biller via one of the open banking APIs for authenticating the payer's credentials with the Biller. Referring to FIG. 6D, as illustrated in the fourth screen 608, a graphical user interface displays a screen for the payer to provide consent for the financial institution/banking application to have access to the data.

With this set-up, the banking application establishes a connection with the bank-as-biller-account and can obtain and display mortgage bill content and other transaction information to the payer in the graphical user interface. In addition, as explained with respect to FIGS. 5A-5E, the banking application can further include a payment command in the graphical user interface such that in response to receiving a selection of the payment command, the banking application can identify the appropriate biller identifier and effect payment.

In a specific implementation supporting the scenarios of FIGS. 2A-2E, FIG. 3A, FIG. 3B, FIGS. 4A-4D, FIGS. 5A-5D, FIGS. 6A-6D, FIGS. 7A-7B, and FIG. 8 the following 7 APIs can be used. For example, for the scenarios illustrated in FIGS. 2A-2E, FIGS. 4A-4D, FIGS. 5A-5D, FIGS. 6A-6D, FIGS. 7A-7B, and FIG. 8 and methods of FIGS. 3A-3B, FIGS. 7A-7B, and FIG. 8 authenticate, register, and connect APIs of the open banking APIs can be used.

Partner Authentication API—Once a financial institution associated with the banking application has enrolled in Bill Pay Open Banking Service and established connectivity, the financial institution can start adding real Payer data to its application. The financial institution authenticates with Bill Pay Open Banking Service by calling the ‘Partner Authentication’ API. This API can run every time the financial institution's token expires; of course, other triggers for refreshing tokens can be used.

Creating an Active Customer API—the financial institution (e.g., through the financial institution application server) registers its Payer by calling the ‘Creating an Active Customer’ API. The financial institution completes this call for each Payer. This API creates a customer ID which is linked to all account data. A connect fix API can be available to reauthenticate a Payer with a Biller if there is an issue with matching the account information. It can also be possible to link multiple accounts at a biller so long as a customer provides each account number. A delete customer API can also be available to delete a particular payer.

Connect Lite API—this service can be used by the financial institution to link its Payer to the Biller. The financial institution (e.g., through the financial institution application server) can call the ‘Connect Lite’ API, which returns a URL link that the financial institution can use to implement ‘Connect Lite’ in its own web or mobile applications. The Payer can leverage ‘Connect Lite’ to authenticate with the Biller and give permission for the DI to access data. A Payer goes through this process with each biller. If a Payer has multiple accounts with a biller, they can authenticate with multiple accounts through one request. At the end of this process an authentication token will be generated, and this will be used to pull the Payer data going forward. A ‘Delete Account API’ can be used to delete a linked account.

‘Connect Fix’ API—‘Connect Fix’ API provides a flow for customers to re-authenticate to their accounts when the connection to the user's financial institution is lost. The connection to the Payer's accounts can stop working if the account password has changed or the token provided by the financial institution has been revoked.

For the scenario of FIGS. 2A-2E, get data APIs of the open banking APIs can be used.

Get Customer Accounts API—financial institutions can pull updated information daily (or some other regular occasions), on each linked account, by calling the ‘Get Customer Accounts’ API. Financial institutions can decide how often they want to receive updated account data by calling this API. For example, the financial institution may pull the data once every bill cycle. The financial institution can monitor the ‘Due Date’ of a bill every day, and when the ‘Due Date’ changes, notify the Payer that they are in a new billing cycle. Once a Payer has linked to an account at a biller, Bill Pay Open Banking Service can pull data from the biller, for example, on a nightly basis.

Refresh Customer Accounts API—A financial institution can call the ‘Refresh Customer Accounts’ API to have account information available immediately after linking (near real-time). This API retrieves refreshed data from the biller.

Get Customer Account Transactions API—this API enables the financial institution to pull all transactions on a customer's account.

The use of the described open banking APIs can establish an open banking data connection that can provide expansive visibility into finanical information for a user. This data can be used to provide account information and details supporting a plurality of features that can enhance the experience of a user (e.g., a user using a banking application). The following are examples of potential features that utilize the open banking data connection established using the described open banking APIs. For example, the following features may be included in a banking application, such as the banking application described with respect to FIGS. 2A-2E, FIG. 3A, FIG. 3B, FIGS. 4A-4D, FIGS. 5A-5D, FIGS. 6A-6D, FIGS. 7A-7B, and FIG. 8.

A “quick pay” feature (e.g., a button, a hyperlink, or an alternative interactive option) can leverage open banking data to present selectable payment options for a user. This feature may include auto-populating the payment amount field for the user. Additionally, the quick pay feature may, after auto-populating the payment amount field, proceed to pay the payment amount. For example, a user can select to pay an amount (e.g., a minimum balance, a statement balance, or a statement balance and pending amount); the selected amount can then be auto-populated and paid based on the user's selection.

A “view account details” feature (e.g., a button, a hyperlink, or an alternative interactive option) can leverage the open banking data connection to provide a view of transactional level details tied to the account (e.g., pending transactions, interest, principal, escrow, etc.).

A “bill categorization” feature may utilize the open banking data connection to provide account type data (e.g., credit card, mortgage loan, etc.) to the user, allowing a user to easily visualize various categorizations of bills.

A “bill notification” feature can utilize the open banking data connection to identify and inform the user that a particular bill is coming due. The bill notification can include details on the user's ability to pay said bill (e.g., a user's financial account balance). For example, if a user has insufficient funds in a particular account, the user may be presented with an interactive option to deposit funds into that and pay the bill. As an additional example, if a user has sufficient funds, the user may be presented with an interactive option to pay now (e.g., using the “quick pay” feature described herein).

A “multiple account details” feature can leverage the open banking data connection to share summary bill details for multiple accounts (e.g., all linked accounts in a for a user).

A “completed payments” or “receipting” feature can leverage open banking data to monitor accounts after a payment has been made against an account to monitor when the account balance has drawn down, and as a result, may provide a notification to the user.

An “upcoming due date notification” feature may leverage the open banking data connection to notify a user of an upcoming due date (e.g., for a mortgage payment, credit card payment, auto loan payment, etc.).

An “account balance notification” may leverage the open banking data connection to monitor upcoming bills. In some cases, the “account balance notification feature” can include monitoring a user's account to ensure that a user has sufficient funds or an adequate account balance to cover the cost of the upcoming bill.

A “high credit card balance” feature may leverage the open banking data connection to notify a user if a certain credit card balance has been exceeded (e.g., via an alert sent to the user's mobile device).

A “large transaction” feature may leverage the open banking data connection to notify a user of a large pending transaction on a credit card (e.g., via an alert sent to the user's mobile device).

A “payment date suggestion” feature may leverage the open banking data connection (e.g., by monitoring and/or examining bill data and account balance history) to suggest the best days to pay particular bills.

A “payee setup corrections” feature may leverage the open banking data connection (e.g., by monitoring and/or examining updates on account data) to notify a user to update payee setup details.

A “new payee setup” feature may leverage the open banking data connection (e.g., by monitoring and/or examining transaction details) to identify new bill pay payee setups.

A “targeted cross sell” feature may leverage the open banking data connection (e.g., by monitoring and/or examining transaction history) to identify products to cross sell to a user.

A “loan maturity notification” feature may leverage the open banking data connection to notify a user when a loan will mature (and that the user is no longer required to send payments).

An “account closure notification” feature may leverage the open banking data connection to notify a user when an account is closed.

A “credit balance notification” feature may leverage the open banking data connection to notify the user when a payment could lead to a credit balance.

A “spending behavior analysis” feature may leverage the open banking data connection (e.g., by monitoring and/or examining checking account details and/or credit card transaction details) to provide the user with an analysis (e.g., a report) of their spending behavior (e.g., spending behavior as monitored across a plurality accounts).

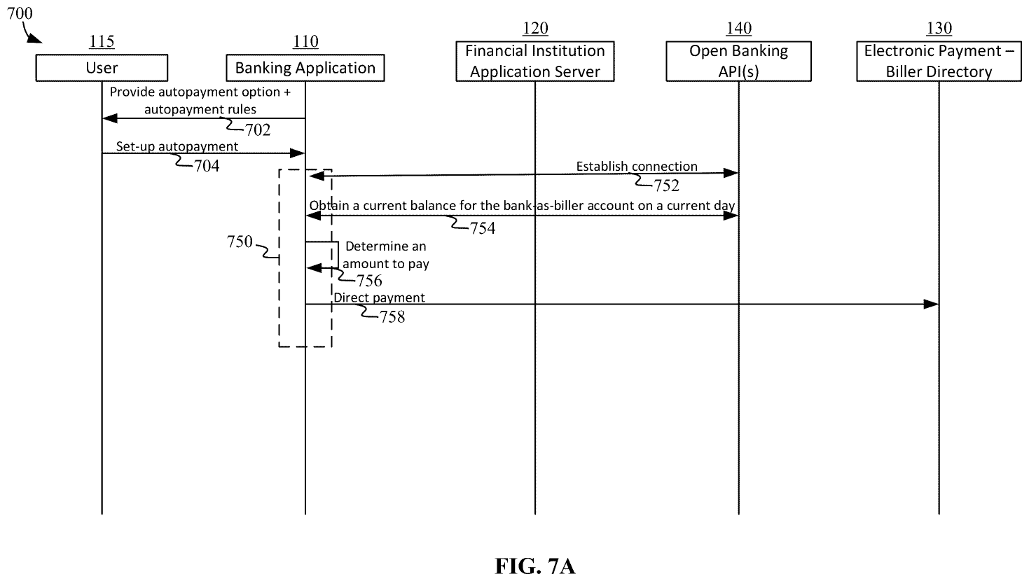

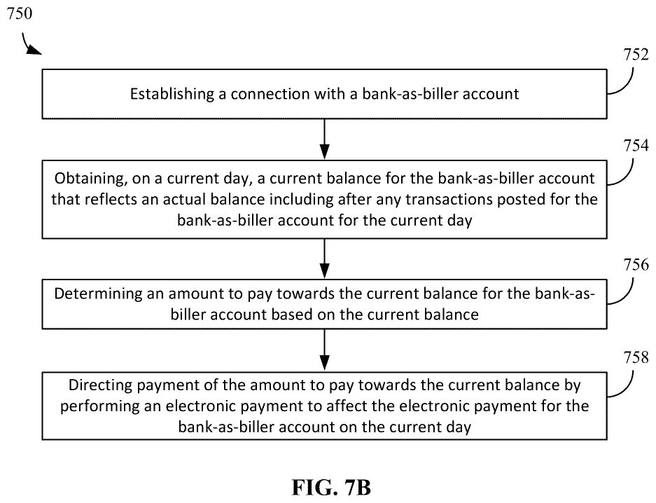

An “autopay for variable bills” feature may leverage the open banking data connection to drive autopay for amounts that vary (e.g., vary month to month). For example, FIG. 7A illustrates a process for an autopayment for a variable bill on a current day.

An autopayment, or automatic payment, is a service that automatically transfers funds from a bank account to a company or vendor to pay a recurring bill. In many cases, an autopayment can be set up for a fixed bill, for example, an autopayment of $10.99 each month on the 1^{st} of the month to Company X for a monthly subscription service.

However, conventionally, autopayment for variable bills can present unique challenges.

A variable bill is a bill that can fluctuate bill to bill (e.g., month-to-month, annually, etc.). Variable bills totals can vary depending on different factors. For example, a bill for credit card account can be a variable bill because the amount due (e.g., current balance) can fluctuate based on the particular transactions made within the given time period.

Currently, for scenarios where the banking application lacks the established open banking data connection described herein, when a user sets up an autopayment for a variable bill for an account at a company different than the banking application, a user has limited options for the autopayment.

For example, the user can set up an autopayment amount for a fixed amount, regardless of a current balance reflected in an e-bill. For example, the user may select to have the autopayment amount total be $2,000 at a particular time each month.

Alternatively, the user can set up an autopayment for a current balance reflected in the e-bill (e.g., the variable bill). For example, the user may select to have the autopayment amount total be the current statement balance or current account balance at a particular time each month.

The user's options are limited because the banking application does not have access to current balance and/or updated transaction information for a particular current day that occurs after an e-bill is received. Typically, an e-bill is received at a same or similar day of a month (e.g., first of every month) and includes only the transactions that were recorded and/or pending on or before the date the e-bill is generated.

As an illustrative example, consider that, at a banking application that does not have an established open banking data connection, a user selects to set up recurring autopayment for a particular account (e.g., credit card account) at an institution not associated with the banking application (e.g., Company A). The user may direct that the autopayment for the particular account is made on the 15^{th} of every month, where the amount to be paid for the autopayment is the current statement balance of the e-bill associated with the particular account.

However, the e-bill associated with the particular account received by the banking application (e.g., via a finanical institution application server) may not reflect the current statement balance as of the 15^{th} of the month, because the banking application may receive an e-bill associated with the particular account from Company A on the 1^{st} of every month. This e-bill including transactions associated with the particular account up and until the 1st of the month.

Therefore, when the 15^{th} of the month arrives, and the autopayment for the particular account is triggered, the autopayment amount associated with the particular account sent to Company A will be the amount of the current statement balance as of the e-bill received on the 1^{st} of the month. Because the current statement balance of the e-bill does not include any transactions made between the 1^{st} of the month to the 15^{th} of the month, the autopayment amount will not reflect a current statement balance as of the 15^{th} of the month, when the autopayment occurs.

Advantageously, because of the established connection described herein that allows the banking application 110 (e.g., via the financial institution application server 120) to access the open banking API(s) 140, the banking application 110 can support autopayments for variable bills that reflect a current balance for a current day.

FIG. 7A illustrates an example process for an autopayment for a variable bill on a current day. Referring to FIG. 7A, process 700 for an autopayment for a variable bill on a current day can begin when a banking application 110 provides (702) an autopayment option, including a variety of autopayment rules associated with the autopayment and the user 115 sets up (704) an autopayment at a banking application 110 for a bank-as-biller account. In some cases, the bank-as-biller account can be a credit card account or a debit card account. In some cases, the bills owed to the bank-as-biller account are variable bills.

When setting up (704) the autopayment, the user 115 may designate various autopayment rules associated with the autopayment for the bank-as-biller account. For example, the user 115 may designate an autopayment amount and an autopayment date, among other various other examples of autopayment discussed herein.

Then, based on the autopayment rules, the banking application 110 can complete an autopayment for a variable bill for the bank-as-biller account, for example, via method 750.

FIG. 7B illustrates a method of completing an autopayment for a variable bill for a bank-as-biller account at a banking application. Method 750 can be performed by banking application 110, finanical institution application server 120 or a combination thereof.

Referring to FIGS. 7A-7B, while performing method 750, at some point in time, banking application 110 can establish (752) a connection with the bank-as-biller account using an open banking identifier associated with the bank-as-biller account. The bank-as-biller account can be associated with a financial institution different than that of the banking application.

The banking application 110 can establish (752) the connection with the bank-as-biller account via open banking API(s) 140, as described herein. The banking application 110 can establish (752) the connection with the bank-as-biller account before or after the user sets up (704) an autopayment for the bank-as-biller account.

The bank-as-biller account can be associated with a biller identifier for electronic payment to the bank-as-biller account.

The autopayment can be completed on a day specified by the user 115 when the user 115 sets up (704) the autopayment. For example, during the set up (704), the user 115 may have designated that the autopayment for the bank-as-biller account is the 15^{th} of each month. In some cases, where the user 115 does not specify a particular day for the autopayment, there may be a default day for the autopayment to occur.

The day the autopayment is to be completed is referred to herein as the “current day”.

On a current day, the banking application 110 can obtain (754) a current balance for the bank-as-biller account that reflects an actual balance including after any transactions posted for the bank-as-biller account for the current day.

The banking application 110 can obtain (754), on a current day, a current balance for the bank-as-biller account for the current day by calling an open banking API 140 over the established connection with the bank-as-biller account on the current day and receiving information associated with the bank-as-biller account, for example, the current balance. In some cases, the current balance for the bank-as-biller includes a current statement balance. The current statement balance can reflect any credits to the bank-as-biller account subsequent to the closing date of the statement balance. In some cases, the current balance for the bank-as-biller includes a current account balance. The information associated with the bank-as-biller account can include transaction level details.

Notably, the banking application 110 obtains the current balance on the current day via the established connection, as opposed to relying on information included an e-bill. This allows user 115 to make most up-to-date autopayments from a banking application 110 for accounts not associated with the banking application (e.g., the bank-as-biller account). In some cases, the banking application 110 (e.g., via a different connection) can receive an e-bill associated with the bank-as-biller account that includes a total balance (e.g., a statement balance and/or a total account balance), where the total balance is different than the current balance obtained (754) by the banking application 110 on the current day.

After obtaining (754), on the current day, a current balance for the bank-as-biller account, the banking application can determine (756) an amount to pay towards the current balance for the bank-as-biller account based on the current balance. In some cases, the banking application can determine (756) an amount to pay towards the current balance based on an autopayment rule associated with the bank-as-biller account (e.g., as provided (702) by the banking application 110 and selected by user 115 at (704).

Then, once the banking application 110 has determined an amount to pay towards the current balance for the bank-as-biller account based on the current balance, the banking application 110 can direct (758) payment of the amount to pay towards the current balance by performing an electronic payment to effect the electronic payment for the bank-as-biller account on the current day (e.g., via the electronic payment-biller directory 130).

The following are example implementations of method 750 based on various different autopayment rules.

In some cases, method 750 can further include providing an autopayment rule to pay a current statement balance. Then, on the current day, determining (756) an amount to pay towards the current balance can include determining, based on the autopayment rule, that the amount to pay towards the current balance is the current statement balance.

In some cases, method 750 can further include providing an autopayment rule to pay a minimum amount due. Then, on the current day, the banking application 110 can obtain, via the connection with the bank-as-biller account, a current minimum amount due associated with the current statement balance. Based on the autopayment rule to pay a minimum amount due, determining (756) that the amount to pay towards the current balance can include determining that the amount to pay towards the current balance is the current minimum amount due.

In some cases, method 750 can further include providing an autopayment rule to pay a particular fixed amount.

In some cases, method 750 can further include providing a first autopayment adjustment rule to pay the current statement balance instead of the particular fixed amount if the current statement balance is less than the particular fixed amount. The first autopayment adjustment rule can be associated with the autopayment rule to pay a particular fixed amount.

Then, on the current day, determining (756) the amount to pay towards the current balance can include determining that the current statement balance is less than the particular fixed amount; and determining, based on the first autopayment adjustment rule, that the amount to pay towards the current balance is the current statement balance.

For example, in some cases, the autopayment rule associated with the bank-as-biller account may state that the particular fixed amount to be paid towards the current statement balance is $500. However, there may be a month when the current statement balance associated with the bank-as-biller account is $250. Based on this autopayment adjustment rule, in this scenario, the banking application 110 would pay the current statement balance instead of the particular fixed amount.

In some cases, method 750 can include providing a providing a second autopayment adjustment rule to pay the particular fixed fee even if the current statement balance is less than the particular fixed amount if there is a remaining account balance associated with the bank-as-biller account greater than zero. The second autopayment adjustment rule can be associated with the autopayment rule and the first autopayment adjustment rule.

On the current day, the banking application 110 can obtain, via the connection with the bank-as-biller account, a current remaining account balance associated with the bank-as-biller account. Determining (756) the amount to pay towards the current balance can include determining that the current remaining account balance is greater than zero; and determining, based on the second autopayment adjustment rule, that the amount to pay towards the current balance is the particular fixed fee amount.

For example, consider the example provided above. The autopayment rule associated with the bank-as-biller account may state that the particular fixed amount to be paid towards the current balance is $500 and the current statement balance associated with the bank-as-biller account is $250. However, the current remaining account balance associated with the bank-as-biller account may be $2,000. Based on this second autopay adjustment rule, in this scenario, the banking application 110 would pay the particular fixed amount.

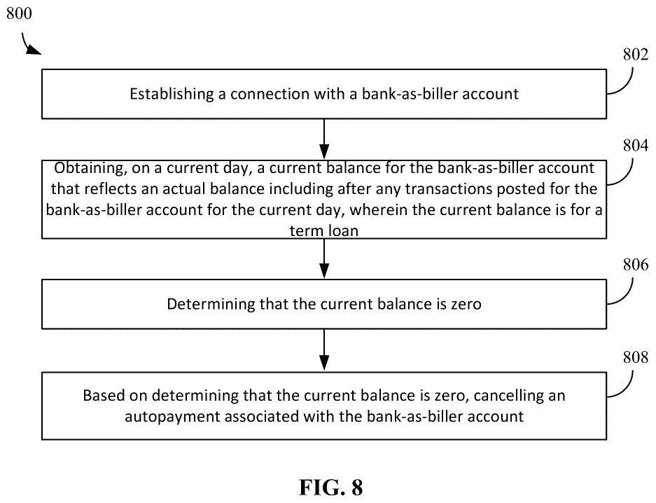

FIG. 8 illustrates an example method for cancelling an autopayment for a term loan.

Referring to FIG. 8, method 800 can include establishing (802), at a banking application, a connection with a bank-as-biller account using an open banking identifier associated with the bank-as-biller account, wherein the bank-as-biller account has a biller identifier for electronic payment to the bank-as-biller account; obtaining (804) on a current day, at the banking application via the connection with the bank-as-biller account, a current balance for the bank-as- biller account that reflects an actual account balance including after any transactions posted for the bank-as-biller account for the current day, wherein the current balance is for a term loan; determining (806) that the current balance is zero; and based on determining that the current balance is zero, cancelling (808) an auto-payment associated with the bank-as-biller account.

In some cases, in response to cancelling the autopayment associated with the bank-as-biller account, the banking application can provide a notification that the autopayment has been cancelled (e.g., via a SMS message, via graphical user interface of a banking application, etc.). In some cases, the notification can indicate that the term loan has matured.

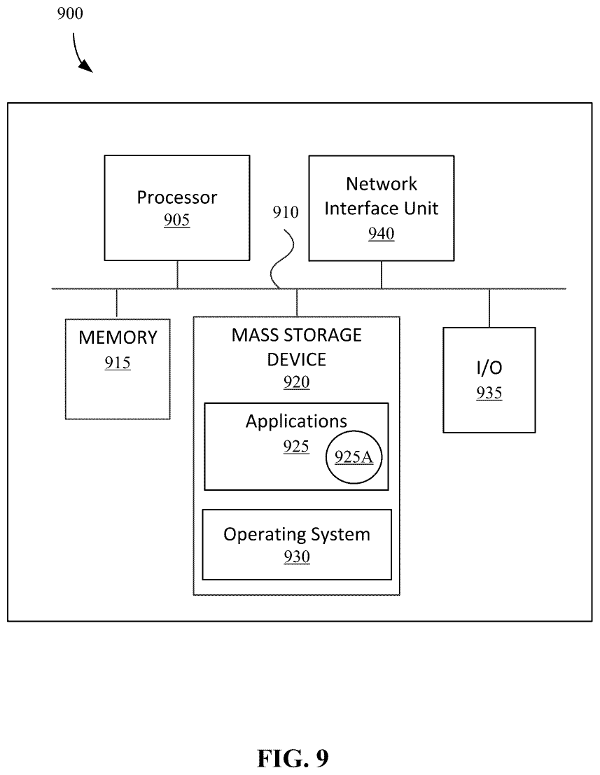

FIG. 9 illustrates a block diagram illustrating components of a computing device used in some embodiments. It should be understood that aspects of the system described herein are applicable to both mobile and traditional desktop computers, as well as server computers and other computer systems. Components of computing device 900 may represent a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, an electronic whiteboard or large form- factor touchscreen, or a server, as some examples. Accordingly, more or fewer elements described with respect to computing device 900 may be incorporated to implement a particular computing device.

Referring to FIG. 9, a computing device 900 can include at least one processor 905 connected to components via a system bus 910; a system memory 915 and a mass storage device 920. A processor 905 processes data according to instructions of one or more application programs 925, and/or operating system 930. Examples of processor 905 include general purpose central processing units (CPUs), graphics processing units (GPUs), field programmable gate arrays (FPGAs), application specific processors, and logic devices, as well as any other type of processing device, combinations, or variations thereof. Processor 905 may be, or is included in, a system-on-chip (SoC) along with one or more other components such as sensors (e.g., magnetometer, an ambient light sensor, a proximity sensor, an accelerometer, a gyroscope, a Global Positioning System sensor, temperature sensor, shock sensor) and network connectivity components (e.g., including network interface 940).

The one or more application programs 925 may be loaded into the mass storage device 920 and run on or in association with the operating system 930. For example, a banking application 925A with in-application transaction interface functionality as described herein can also be stored on the mass storage device 920. Banking application 925A may include instructions to perform methods 750 and 800, as well as instructions for providing the feature functionality described herein.

Certain functionality and data can be made available to the banking application 925A via the network interface 940.

It can be understood that the mass storage device 920 may involve one or more memory components including integrated and removable memory components and that one or more of the memory components can store an operating system. Examples of mass storage device 920 include removable and non-removable storage media including random access memory, read only memory, magnetic disks, optical disks, CDs, DVDs, flash memory, magnetic cassettes, magnetic tape, magnetic disk storage or other magnetic storage devices, or any other suitable storage media. Mass storage device 920 (which may also be referred to as a computer readable storage medium/media) does not consist of propagating signals or carrier waves.

The system memory 915 may include a random-access memory (“RAM”) and/or a read-only memory (“ROM”). The RAM generally provides a local storage and/or cache during processor operations and the ROM generally stores the basic routines that help to transfer information between elements within the computer architecture such as during startup.

The system can further include user interface system 935, which may include input/output (I/O) devices and components that enable communication between a user and the computing device 900. User interface system 935 can include one or more input devices such as, but not limited to, a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 935 may also include one or more output devices such as, but not limited to, display screen(s), speakers, haptic devices for tactile feedback, and other types of output devices. In certain cases, the input and output devices may be combined in a single device, such as a touchscreen display which both depicts images and receives touch gesture input from the user.

The network interface 940 allows the system to communicate with other computing devices, including server computing devices and other client devices, over a network. The network interface 940 can include a unit to perform the function of transmitting and receiving radio frequency communications to facilitate wireless connectivity between the system and the “outside world,” via a communications carrier or service provider. Transmissions to and from the network interface 940 are conducted under control of the operating system 930, which disseminates communications received by the network interface 940 to application programs 925 and vice versa.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims presented now or in the future.

What is claimed is:

1. A method, comprising:
establishing, at a banking application, a connection with a bank-as-biller account associated with a financial institution different than that of the banking application using an open banking identifier associated with the bank-as-biller account, wherein the bank-as-biller account has a biller identifier for electronic payment to the bank-as-biller account;
obtaining, on a current day, at the banking application via the connection with the bank-as-biller account, a current balance for the bank-as-biller account that reflects an actual balance including after any transactions posted for the bank-as-biller account for the current day;
determining an amount to pay towards the current balance for the bank-as-biller account based on the current balance; and
directing payment of the amount to pay towards the current balance by performing an electronic payment using the biller identifier associated with the bank-as-biller account to effect the electronic payment for the bank-as-biller account on the current day.

2. The method of claim 1, wherein the current balance includes a current statement balance for the bank-as-biller account reflecting any credits to the bank-as-biller account.

3. The method of claim 2, further comprising:
providing an autopayment rule to pay the current statement balance; and
wherein determining the amount to pay towards the current balance comprises determining, based on the autopayment rule, that the amount to pay towards the current balance is the current statement balance.

4. The method of claim 2, further comprising:
providing an autopayment rule to pay a minimum amount due;
obtaining, on the current day, at the banking application via the connection with the bank-as-biller account, a current minimum amount due associated with the current statement balance;
wherein determining that the amount to pay towards the current balance comprises determining, based on the autopayment rule, that the amount to pay towards the current balance is the current minimum amount due.

5. The method of claim 2, further comprising:
providing an autopayment rule to pay a particular fixed amount;
providing a first autopayment adjustment rule associated with the autopayment rule to pay the current statement balance instead of the particular fixed amount if the current statement balance is less than the particular fixed amount; and
wherein determining the amount to pay towards the current balance comprises:
determining that the current statement balance is less than the particular fixed amount; and
determining, based on the first autopayment adjustment rule, that the amount to pay towards the current balance is the current statement balance.

6. The method of claim 5, wherein the current balance further includes an account balance, the method further comprising:
providing a second autopayment adjustment rule associated with the autopayment rule and the first autopayment adjustment rule to pay the particular fixed amount even if the current statement balance is less than the particular fixed amount if there is a remaining account balance associated with the bank-as-biller account greater than zero; and
wherein determining the amount to pay towards the current balance comprises:
determining that the account balance is greater than zero; and
determining, based on the second autopayment adjustment rule, that the amount to pay towards the current balance is the particular fixed amount.

7. The method of claim 2, further comprising:
receiving an electronic bill (e-bill) at the banking application, wherein the e-bill comprises a total statement balance, wherein the total statement balance of the e-bill is different than the current statement balance obtained, on the current day, at the banking application via the connection with the bank-as-biller account.

8. A method, comprising:
establishing, at a banking application, a connection with a bank-as-biller account using an open banking identifier associated with the bank-as-biller account, wherein the bank-as-biller account has a biller identifier for electronic payment to the bank-as-biller account;
obtaining on a current day, at the banking application via the connection with the bank-as-biller account, a current balance for the bank-as-biller account that reflects an actual account balance including after any transactions posted for the bank-as-biller account for the current day, wherein the current balance is for a term loan;
determining that the current balance is zero; and
based on determining that the current balance is zero, cancelling an autopayment associated with the bank-as-biller account.

9. The method of claim 8, further comprising providing a notification that the autopayment has been cancelled.

10. The method of claim 9, wherein the notification indicates that the term loan has matured.

11. A computer-readable storage medium having instructions stored thereon that when executed by a computing system direct the computing system to:
establish, at a banking application, a connection with a first bank-as-biller account associated with a financial institution different than that of the banking application using an open banking identifier associated with the first bank-as-biller account, wherein the first bank-as-biller account has a first biller identifier for electronic payment to the first bank-as-biller account;
establish, at the banking application, a connection with a second bank-as-biller account associated with a financial institution different than that of the banking application using a second open banking identifier associated with the second bank-as-biller account, wherein the second bank-as-biller account has a second biller identifier for electronic payment to the second bank-as-biller account;
provide a first autopayment feature, wherein the instructions to provide the first autopayment feature direct the computing system to:
obtain, on a current day, at the banking application via the connection with the first bank-as-biller account, a first current balance for the first bank-as-biller account that reflects an actual balance including after any transactions posted for the first bank-as-biller account for the current day;
determine an amount to pay towards the first current balance for the first bank-as-biller account based on the first current balance; and
direct payment of the amount to pay towards the first current balance by performing an electronic payment using the first biller identifier associated with the first bank-as-biller account to effect the electronic payment for the first bank-as-biller account on the current day; and
provide a second autopayment feature, wherein the instructions to provide the second autopayment feature direct the computing system to:
obtain, on the current day, at the banking application via the connection with the second bank-as-biller account, a second current balance for the second bank-as-biller account that reflects an actual account balance including after any transactions posted for the second bank-as-biller account for the current day, wherein the second current balance is for a term loan;
determine that the second current balance is zero; and
based on determining that the second current balance is zero, cancel an autopayment associated with the second bank-as-biller account.

12. The computer-readable storage medium of claim 11, wherein the first current balance includes a first current statement balance for the first bank-as-biller account reflecting any credits to the first bank-as-biller account.

13. The computer-readable storage medium of claim 12, further comprising instructions to:
provide an autopayment rule to pay the first current statement balance; and
wherein the instructions to determine the amount to pay towards the first current balance further direct the computing system to determine, based on the autopayment rule, that the amount to pay towards the first current balance is the first current statement balance.

14. The computer-readable storage medium of claim 12, further comprising instructions to:
provide an autopayment rule to pay a minimum amount due;
obtain, on the current day, at the banking application via the connection with the first bank- as-biller account, a current minimum amount due associated with the first current statement balance;
wherein the instructions to determine the amount to pay towards the first current balance further direct the computing system to determine, based on the autopayment rule, that the amount to pay towards the first current balance is the current minimum amount due.

15. The computer-readable storage medium of claim 12, further comprising instructions to:
provide an autopayment rule to pay a particular fixed amount;
provide a first autopayment adjustment rule associated with the autopayment rule to pay the first current statement balance instead of the particular fixed amount if the first current statement balance is less than the particular fixed amount; and
wherein the instructions to determine the amount to pay towards the first current balance further direct the computing system to:
determine that the first current statement balance is less than the particular fixed amount; and
determine, based on the first autopayment adjustment rule, that the amount to pay towards the first current balance is the first current statement balance.

16. The computer-readable storage medium of claim 15, wherein the first current balance further includes a first account balance, wherein the instructions further direct the computing system to:
provide a second autopayment adjustment rule associated with the autopayment rule and the first autopayment adjustment rule to pay the particular fixed amount even if the first current statement balance is less than the particular fixed amount if there is a remaining account balance associated with the first bank-as-biller account greater than zero; and
wherein the instructions to determine the amount to pay towards the first current balance further direct the computing system to:
determine that the first account balance is greater than zero; and
determine, based on the second autopayment adjustment rule, that the amount to pay towards the first current balance is the particular fixed amount.

17. The computer-readable storage medium of claim 11, further comprising instructions to receive an electronic bill (e-bill) at the banking application, wherein the e-bill comprises a total statement balance, wherein the total statement balance of the e-bill is different than the first current balance obtained, on the current day, at the banking application via the connection with the bank- as-biller account.

18. The computer-readable storage medium of claim 11, further comprising instructions to provide a notification that the autopayment has been cancelled.

19. The computer-readable storage medium of claim 18, wherein the notification indicates that the term loan has matured.
